(19) United States
(12) Patent Application Publication
(10) Pub. No.: US 2015/0176306 A1
(43) Pub. Date: Jun. 25, 2015

(54) DOUBLE LOCK DEVICE FOR A LUGGAGE CASE

(71) Applicant: WEI-HUNG LAI, Taichung City (TW)

(72) Inventor: WEI-HUNG LAI, Taichung City (TW)

(21) Appl. No.: 14/135,869

(22) Filed: Dec. 20, 2013

(51) Int. Cl. E05B 15/00

(52) U.S. Cl. CPC E05B 15/00

(57) ABSTRACT

A double lock device for a luggage case with double lock is provided with a base, a cover, two first locking members and two second locking members, four elastic blocks, a locking unit and a drive member. The double lock device is capable of improving anti-theft effect by simultaneously locking two zippers, and when the locking unit is in a unlocked position, one or both zippers can be locked or unlocked easily by pushing the locking unit up or down with one hand. In addition, the locking of the zippers is achieved by the locking device and the locking pieces disposed on the pull tabs, so that the locking position of the zippers can be adjusted to better fit personal habits.

### BACKGROUND OF THE INVENTION

1. Field of the Invention

The present invention relates to a luggage case, and more particularly to a double lock device for a luggage case.

2. Description of the Prior Art

Luggage cases are mostly provided with locks in order to prevent someone opening the case and stealing the goods contained in the case.

FIG. 1 is a side view of a conventional luggage case with locking function, wherein the luggage case comprises a case body 11, a first cover 13 which is pivoted to the case body 11 to define a first chamber 12 with respect to the case body 11, a second cover 15 which is pivoted to the first cover 13 to define a second chamber 14 with respect to the first cover 13, a first zipper 16 disposed between the case body 11 and the first cover 13, a second zipper 17 disposed between the first cover 13 and the second cover 15, and a lock 18 fixed to the lateral side of the case body 11. The lock 18 serves to lock the first zipper 16 so as to prevent unauthorized opening of the case body 11 and the first cover 13 and stealing of goods contained therein.

The problem is that the lock 18 is located at the lateral side of the case body 11 to lock the first zipper 16, only the first chamber 12 can be protected from stealing, however, the second zipper 17 cannot be locked by the lock 18, therefore, the second chamber 14 is not lockable.

The present invention has arisen to mitigate and/or obviate the afore-described disadvantages.

### SUMMARY OF THE INVENTION

The primary objective of the present invention is to provide a double lock device for a luggage case, wherein two zippers of the luggage case can be locked simultaneously by changing the structural design of the lock device and placing the lock device at the specific positions on the luggage case, so as to prevent unauthorized opening of the luggage case and stealing of goods contained therein.

Another objective of the present invention is to provide a double lock device for a luggage case, when the locking unit is in a unlocked position, one or both zippers can be locked or unlocked easily by pushing the locking unit up or down with one hand.

To achieve the above objectives, a double lock device for a luggage case in accordance with the present invention is disposed on an outer surface of the luggage case, the luggage case comprises a case body, a first cover, a second cover, a zipper between the case body and the first cover, and another zipper between the first and second covers. The double lock device comprises:

a base being a concave hollow structure fixed on the first cover and including a first locking groove and a second locking groove formed on an upper inside of the base, and a third locking groove and a fourth locking grooves formed at a lower inside of the base, an upper clearance being formed between upper walls, lower walls of the first and second locking grooves and an inner wall of the base adjacent to the case body, and a lower clearance being formed between upper walls, lower walls of the third and fourth locking grooves and an outer wall of the base adjacent to the second cover, the upper walls of the first and second locking grooves being each formed with an upper notch and the lower walls of the third and fourth grooves being each formed with a lower notch;

a cover covering the base and being formed with a first opening, a second opening, a third opening and a fourth opening aligned to the first, second, third and fourth locking grooves of the base, in a middle portion of the cover being further defined a slide slot;

two first locking members being an Us-shaped structure and each including a first middle section, and a first abutting portion and a first locking portion formed at two ends of the first middle section, the middle sections of the second locking members being received in the upper and lower clearances of the base in such a manner that the abutting portions are oppositely located at a middle portion of the base, and the locking portions of the first locking members are located between an upper wall of the base and the upper wall of the first locking groove, and between a lower wall of the base and the lower wall of the fourth locking groove, each of the first locking portions being formed with a first locking pin and a first protrusion which extend in opposite directions, the first locking pins being received in the upper notch of the first locking groove and the lower notch of the fourth locking groove, respectively, between each of the first protrusions and the upper and lower walls of the base being disposed a first spring;

two second locking members being an Us-shaped structure including a second middle section, and a second abutting portion and a second locking portion formed at two ends of the second middle section, the second abutting portions of the second locking members being located at the middle portion of the base, and the second middle sections being received in the upper and lower clearances of the base and disposed on the first middle sections of the first locking members, in such a manner that the second locking portions are located between the first and second locking grooves, and between the third and fourth locking grooves of the base, respectively, each of the second locking portions being formed with a second locking pin to be disposed in the upper notch of the second locking groove and the lower notch of the third locking groove, each of the second abutting portions being formed with a second protrusion, between each of the second protrusions and the lower wall of the second locking grove and the upper wall of the third locking groove being disposed a second spring, respectively;

four elastic blocks disposed in the first, second, third and fourth locking grooves of the base for pushing the zippers out of the first, second, third and fourth locking grooves after the zippers are unlocked;

a locking unit slidably disposed in the slide slot of the cover and formed with two arc-shaped positioning portions located corresponding to the upper and lower walls of the base, and between the two arc-shaped positioning portions being provided a locking head protruding toward the base, and on the locking head being formed two guiding protrusions; and

a drive member disposed between the base and the locking unit, and including a base portion for holding the locking head, two locking notches being opened in opposite directions and located at upper and lower sides of the base portion, the base portion being formed with two arc-shaped positioning grooves for restricting slide motion of the positioning portions of the locking unit, and two arc-shaped guiding grooves which have the same radius and the same center as the arc-shaped positioning grooves, the arc-shaped guiding grooves being located closer to the center than the arc-shaped positioning grooves, and the arc-shaped guiding grooves being staggered with respect to the arc-shaped positioning grooves, the guiding protrusions being slidably disposed in the two arc-shaped guiding grooves;

by such arrangements, the drive member is rotated by the locking unit to clamp the first and second abutting portions of the first and second locking members with the locking notches, so that the first and second locking members are locked, or, the drive member is driven to slide by the locking unit, and consequently pushes the first and second abutting portions of the first and second locking members at the upper inside or lower inside of the base to move, making the first and second locking pins of the first and second locking members at the upper inside of the base move out of the first and second locking grooves, or making the first and second locking pins of the first and second locking members at the lower inside of the base move out of the third and fourth locking grooves.

### BRIEF DESCRIPTION OF THE DRAWINGS

FIG. 1 shows a conventional single lock device for a luggage case;

FIG. 2 shows a double lock device for a luggage case in accordance with the present invention;

FIG. 3 is an enlarged view showing that the double lock device in accordance with the present invention is disposed on the luggage case;

FIG. 4 is an exploded view of the double lock device if the luggage case in accordance with the present invention;

FIG. 5 is an assembly view of the double lock device of the luggage case in accordance with the present invention;

FIG. 6 is a cross sectional view showing the locked state of the double lock device of the luggage case in accordance with the present invention;

FIG. 7 is a cross sectional view showing the unlocked state of the double lock device of the luggage case in accordance with the present invention;

FIG. 8 is a cross sectional view showing a pushed-up locked state of the double lock device of the luggage case in accordance with the present invention;

FIG. 9 is a cross sectional view showing a pushed-down locked state of the double lock device of the luggage case in accordance with the present invention;

FIG. 10 is an enlarged view showing the unlocked state of the double lock device of the present invention; and

FIG. 11 is an enlarged view showing the locked state of the double lock device of the present invention.

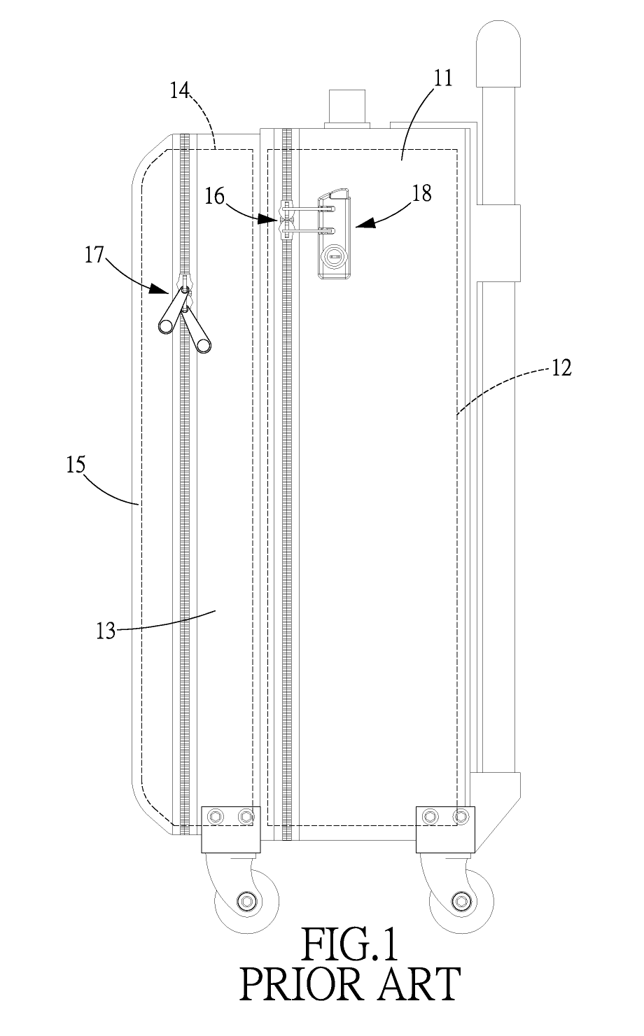

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

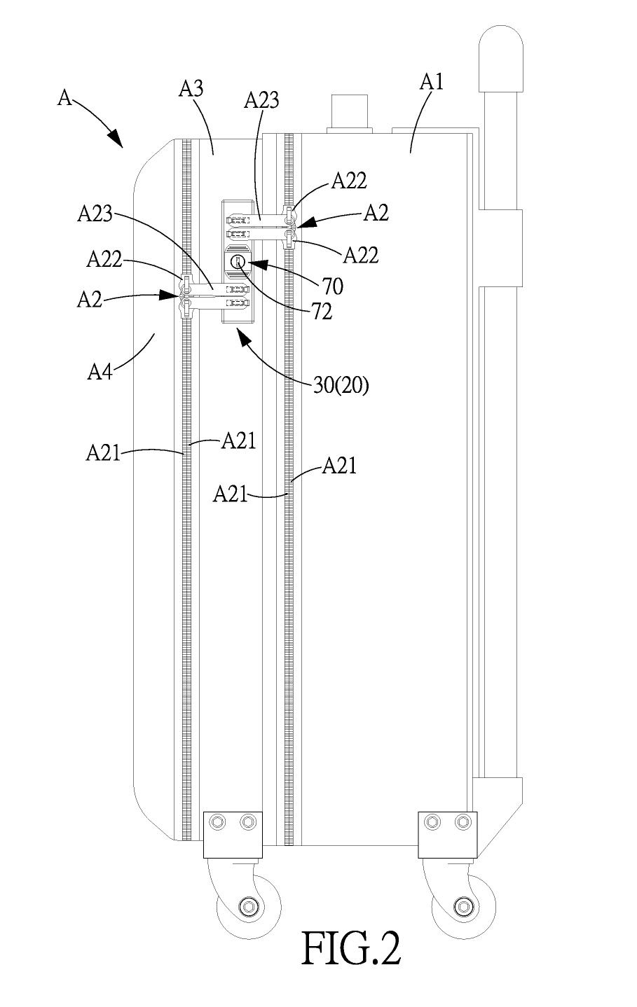

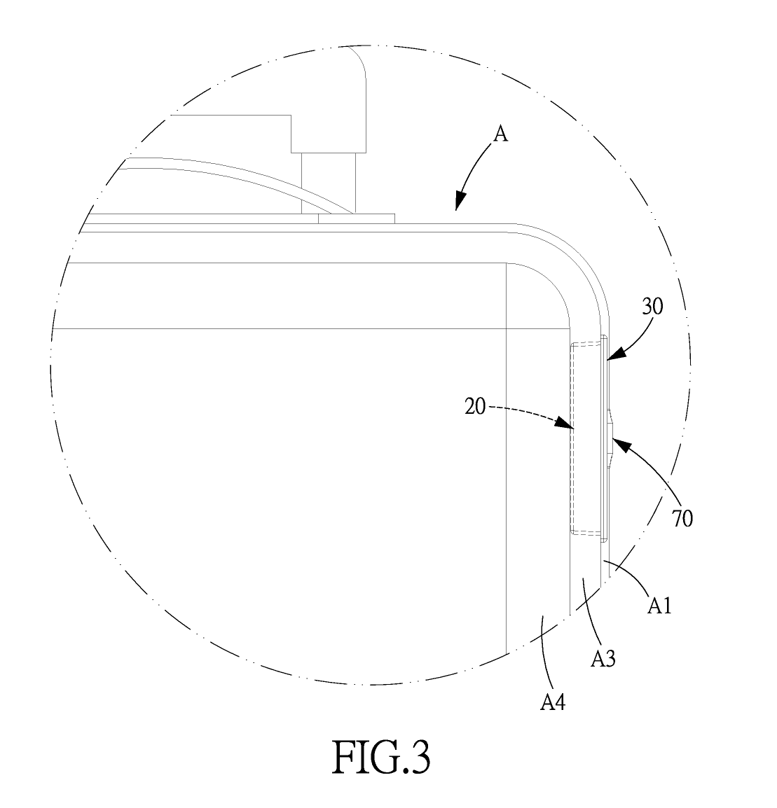

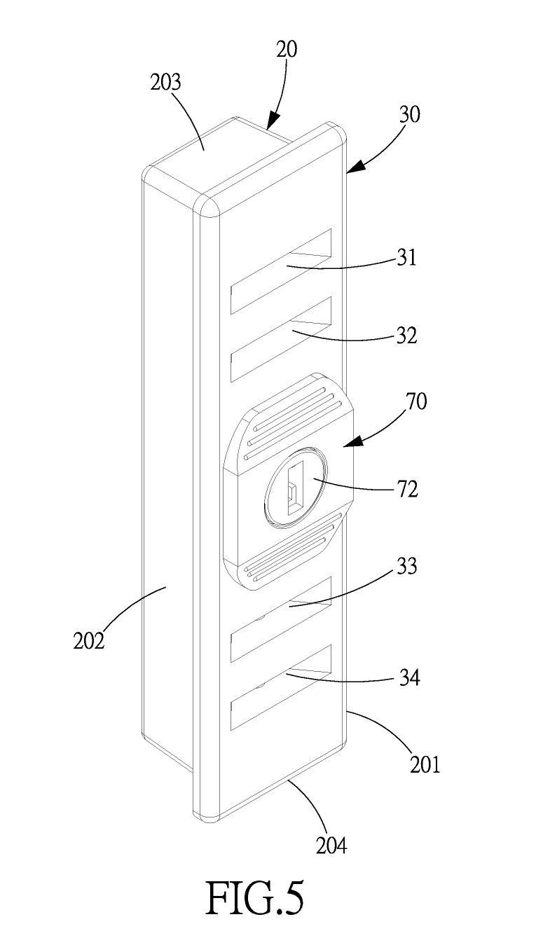

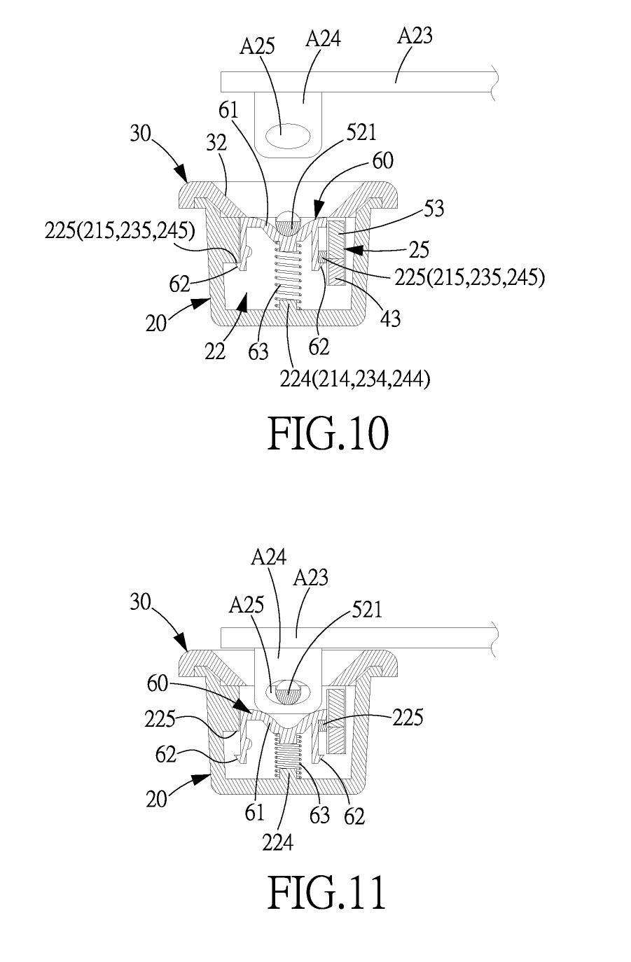

Referring to FIGS. 2-11, a double lock device for a luggage case A in accordance with a preferred embodiment of the present invention is disposed on an outer surface of the luggage case A, wherein the luggage case A comprises: a case body A1, a first cover A3, a second cover A4, a zipper A2 between the case body A1 and the first cover A3, and another zipper A2 between the first and second covers A3, A4. Each of the zippers A2 includes two rows of teeth A21 which are disposed between the case body A1 and between the first and second covers A3, A4, two sliders A22 and two pull tabs A23 assembled to the sliders A22. Each of the pull tabs A23 includes a locking piece A24 to be inserted in first, second, third and fourth locking grooves 21, 22, 23, 24 of a base 20 of the lock device, and an inserting hole A25 for insertion of first and second locking pins 421, 521 of first and second locking members 40, 50.

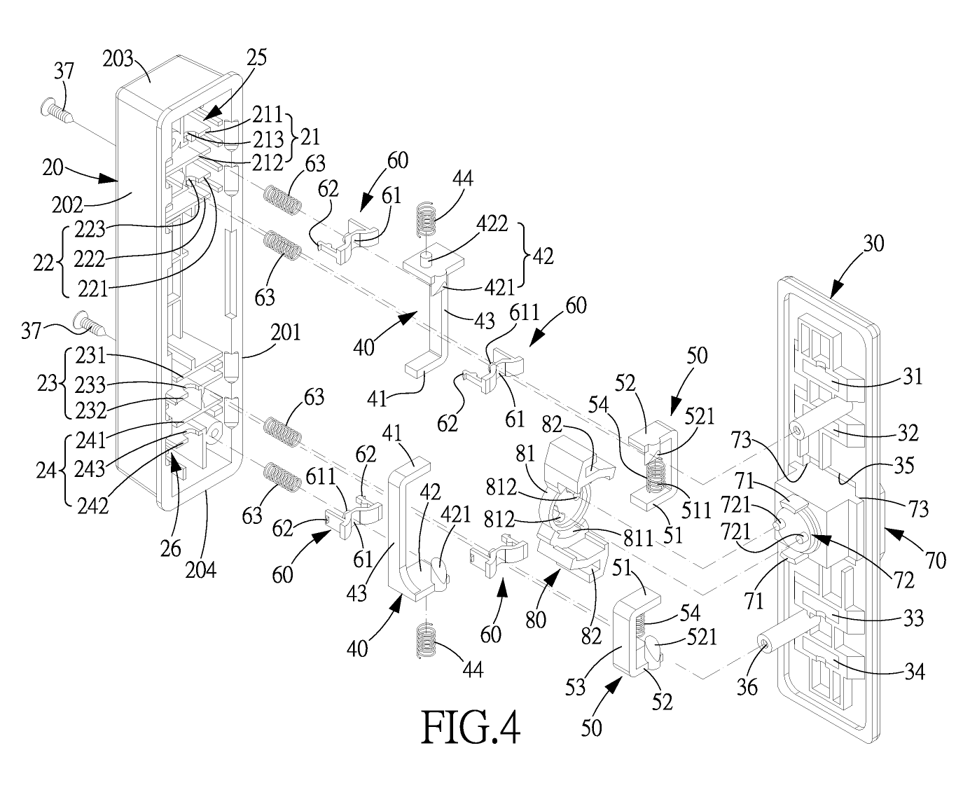

As shown in FIG. 4, the double lock device includes the base 20, a cover 30, two first locking members 40 and two second locking members 50, four elastic blocks 60, a locking unit 70 and a drive member 80.

The base 20 is a concave hollow structure fixed on the first cover A3. The first and second locking grooves 21, 22 are formed on an upper inside of the base 20, and the third and fourth locking grooves 23, 24 are formed at a lower inside of the base 20. An upper clearance 25 is formed between an upper wall 211, 221, a lower wall 212, 222 and an inner wall 201 of the base 20 adjacent to the case body A1, and a lower clearance 26 is formed between an upper wall 231, 241, a lower wall 232, 242 and an outer wall 202 of the base 20 adjacent to the second cover A4. The upper wall 211, 221 of the first and second locking grooves 21, 22 is formed with an upper notch 213, 223, and the lower wall 232, 242 of the third and fourth locking grooves 23, 24 is formed with a lower notch 233, 243.

The cover 30 covers the base 20 and is formed with a first opening 31, a second opening 32, a third opening 33 and a fourth opening 34 aligned to the first, second, third and fourth locking grooves 21, 22, 23, 24 of the base 20. In the middle of the cover 30 is further defined a slide slot 35. In this embodiment, the base 20 is formed with two locking holes 27, the cover 30 has two locking columns 36 inserted and locked in the locking holes 27 by two locking elements 37, so that the cover 30 is fixed to the base 20.

Each of the first locking members 40 is an Us-shaped structure including a first middle section 43, and a first abutting portion 41 and a first locking portion 42 formed at two ends of the first middle section 43. The first middle sections 43 of the first locking members 40 are received in the upper and lower clearances 25, 26 of the base 20 in such a manner that the first abutting portions 41 are oppositely located at the middle portion of the base 20, and the first locking portions 42 of the first locking members 40 are located between an upper wall 203 of the base 20 and the upper wall 211 of the first locking groove 21, and between the lower wall 204 of the base 20 and the lower wall 242 of the fourth locking groove 24. The first locking portion 42 of each of the first locking members 40 is formed with a first locking pin 421 and a first protrusion 422 which extend in opposite directions. The first locking pins 421 are received in the upper notch 213 of the first locking groove 21 and the lower notch 243 of the fourth locking groove 24, respectively. Between each of the first protrusions 422 and the upper and lower walls 203, 204 of the base 20 is disposed a first spring 44. In this embodiment, at the end of each of the first locking pins 421 is formed a first slanting surface, so that the locking pieces A24 of the zippers A2 can push against the first slanting surface to push the first locking pins 421 away from the locking grooves, letting the locking pieces A24 move into the locking grooves.

Each of the second locking members 50 is an Us-shaped structure including a second middle section 53, and a second abutting portion 51 and a second locking portion 52 formed at two ends of the second middle section 53. The second abutting portions 51 of the second locking members 50 are located at the middle portion of the base 20, and the second middle sections 53 are received in the upper and lower clearances 25, 26 of the base 20 and disposed on the first middle sections 43 of the first locking members 40, in such a manner that the second locking portions 52 are located between the first and second locking grooves 21, 22, and between the third and fourth locking grooves 23, 24 of the base 20, respectively. Each of the second locking portions 52 is formed with a second locking pin 521 to be disposed in the upper notch 223 of the second locking groove 22 and the lower notch 233 of the third locking groove 23. Each of the second abutting portions 51 is formed with a second protrusion 511. Between each of the second protrusion 511 and the lower wall 222 of the second locking grove 22 and the upper wall 221 of the third locking groove 23 is disposed a second spring 54. In this embodiment, at the end of each of the second locking pins 521 is formed a second slanting surface, so that the locking pieces A24 of the zippers A2 can push against the second slanting surface to push the second locking pins 521 away from the locking grooves, letting the locking pieces A24 move into the locking grooves.

The four elastic blocks 60 are disposed in the first, second, third and fourth locking grooves 21, 22, 23, 24 of the base 20. In this embodiment, at the bottom of each of the first, second, third and fourth locking grooves 21, 22, 23, 24 of the base 20 is formed a protruding portion 214, 224, 234, 244. Each of the first, second, third and fourth locking grooves 21, 22, 23, 24 is further provided with two hooking portions 215, 225, 235, 245 which are located corresponding to inner and outer walls 201, 202 of the base 20. Each of the elastic blocks 60 is a M-shaped structure which includes a concave middle section 61 and two retaining portions 62 at both ends of the concave middle section 61. Each of the concave middle section 61 of the elastic blocks 60 is formed with a protruding engaging portion 611, and a third spring 63 disposed between each of the protruding engaging portion 611 and each of the protruding portions 214, 224, 234, 244, so as to push the elastic blocks 60 toward the first, second, third and fourth openings 31, 32, 33, 34 of the cover 30.

The locking unit 70 is slidably disposed in the slide slot 35 of the cover 30 and is formed with two arc-shaped positioning portions 71 located corresponding to the upper and lower walls 203, 204 of the base 20, and between the two arc-shaped positioning portions 71 is provided a locking head 72 protruding toward the base 20, and on the locking head 72 are formed two guiding protrusions 721. In this embodiment, two slide grooves 73 are formed at two sides of the locking unit 70 and located corresponding to the inner and outer walls 201, 202 of the base 20, and two lateral edges of the slide slot 35 of the cover 30 are slidably disposed in the slide grooves 73.

The drive member 80 is disposed between the base 20 and the locking unit 70, and includes a base portion 81 for holding the locking head 72. Two locking notches 82 open in opposite directions and are located at upper and lower sides of the base portion 81. The base portion 81 is formed with two arc-shaped positioning grooves 811 for restricting slide motion of the two arc-shaped positioning portions 71 of the locking unit 70, and two arc-shaped guiding grooves 812 which have the same radius and the same center as the arc-shaped positioning grooves 811, so that the guiding protrusions 721 are slidably disposed in the two arc-shaped guiding grooves 812. The arc-shaped guiding grooves 812 are located closer to the center than the arc-shaped positioning grooves 811, and the arc-shaped guiding grooves 812 are staggered with respect to the arc-shaped positioning grooves 811.

The drive member 80 is rotated by the locking unit 70 to clamp the first and second abutting portions 41, 51 of the first and second locking members 40, 50 with the locking notches 82, so that the first and second locking members 40, 50 are locked. Or, the drive member 80 is driven to slide by the locking unit 70, and consequently pushes the first and second abutting portions 41, 51 of the first and second locking members 40, 50 at the upper or lower inside of the base 20 to move, making the first and second locking pins 421, 521 of the first and second locking members 40, 50 at the upper inside of the base 20 move out of the first and second locking grooves 21, 22, or causing the first and second locking pins 421, 521 of the first and second locking members 40, 50 at the lower inside of the base 20 to move out of the third and fourth locking grooves 23, 24.

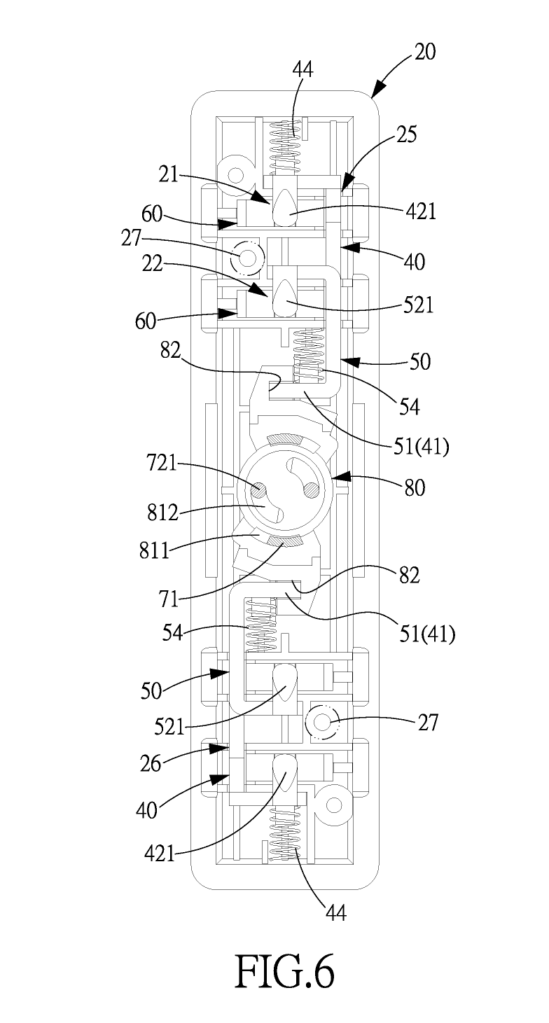

What mentioned above are the structural relations of the components of the preferred embodiment of the present invention, for a better understanding of the invention, its operating advantages and the specific objects attained by its uses, reference should be had to FIGS. 6-11 and the following descriptive matter.

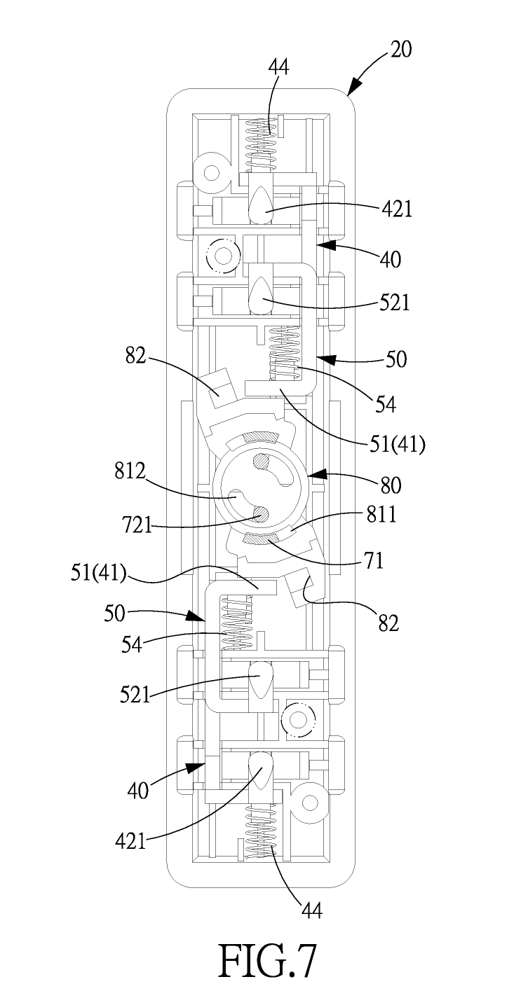

Under normal conditions, the first and second locking members 40, 50 are pressed against by the first and second springs 44, 54, in such a manner that the first and second locking pins 421, 521 of the first and second locking members 40, 50 are disposed in the first, second, third and fourth locking grooves 21, 22, 23, 24 of the base 20 and exposed out of the first, second, third and fourth openings 31, 32, 33, 34 of the cover 30. As shown in FIGS. 6 and 7, the arc-shaped positioning portions 71 and the guiding protrusions 721 of the locking unit 70 are received in the arc-shaped positioning grooves 811 and the arc-shaped guiding grooves 812 of the drive member 80, respectively. Rotating the locking head 72 can make the drive member 80 rotate until the first and second abutting portions 41, 51 of the first and second locking members 40, 50 are restricted in the locking notches 82, so as to prevent the first and second locking members 40, 50 from moving up and down, at this moment, the locking unit 70 is switched into a locked position, as shown in FIG. 6. To lock or unlock the zippers A2, the user can reversely rotate the locking unit 70, so as to drive the locking notches 82 to move away from the first and second abutting portions 41, 51 of the first and second locking members 40, 50, at this moment, the locking unit 70 is switched into a unlocked position, as shown in FIG. 7.

When the locking unit 70 is in the unlocked position, the first and second springs 44, 54 will push the first and second locking members 40, 50 back to original positions, so that the locking pieces A24 of the zippers A2 can be pushed into the locking grooves by pushing against the first slanting surface of the first and second locking pins 421, 521, and then the first and second locking pins 421, 521 will be pushed back into the inserting holes A25 of the locking pieces A24 by the first and second springs 44, 54, thus locking the zippers A2.

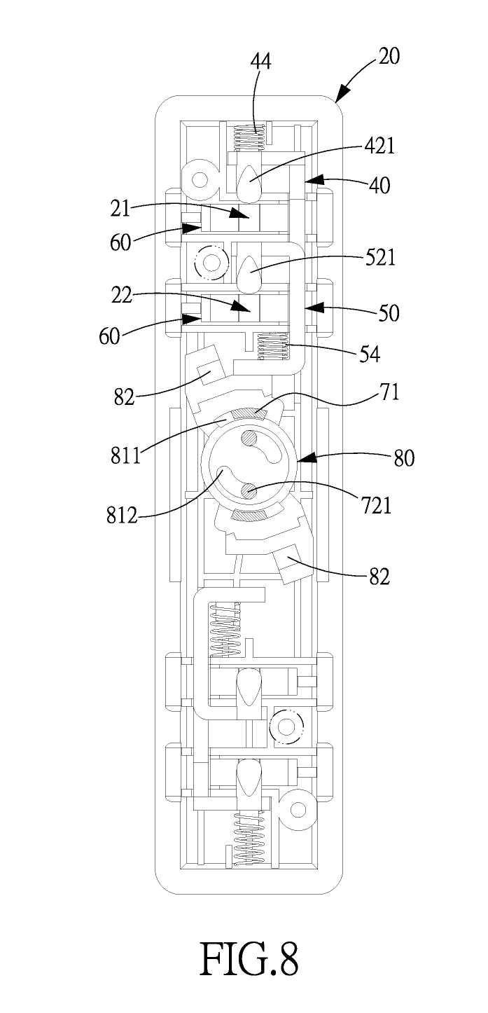

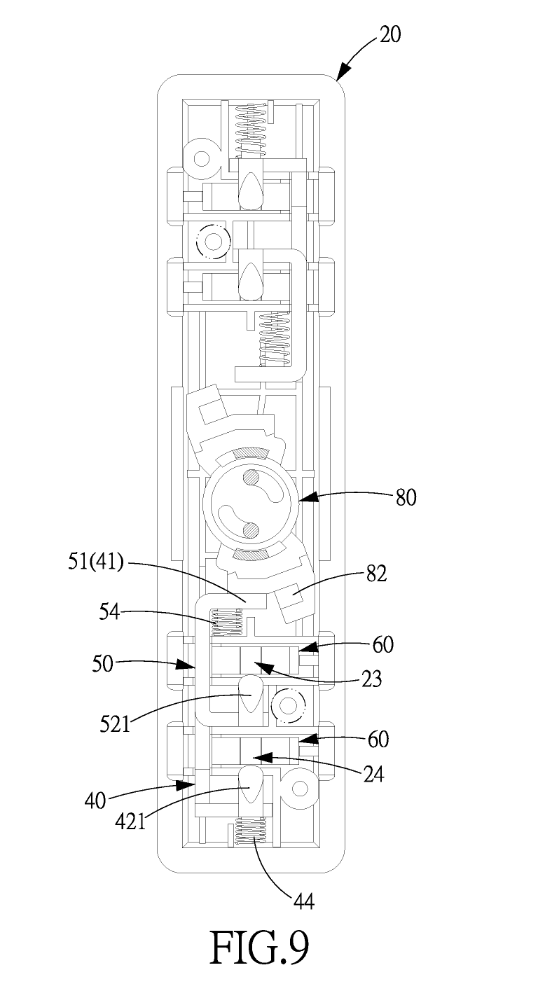

To unlock the locking pieces A24, as shown in FIGS. 8 and 9, the user can push the unlocked locking unit 70 upward or downward, then the drive member 80 is driven to push the first and second locking members 40, 50 at the upper side of the base 20 upward, or the driven member 80 is driven to push the first and second locking members 40, 50 at the lower side of the base 20 to move downward, making the first and second locking pins 421, 521 of the first and second locking members 40, 50 disengage from the inserting holes A25 of the locking pieces A24 and the locking grooves. At this moment, the unlocked locking pieces A24 will be pushed by the elastic blocks 60 to move out of the first, second, third and fourth openings 31, 32, 33, 34 of the cover 30, so that the zippers A2 are unlocked easily.

In general, the double lock device in accordance with the present invention is capable of improving anti-theft effect by simultaneously locking two zippers, and when the locking unit is in a unlocked position, one or both zippers can be locked or unlocked easily by pushing the locking unit up or down with one hand. In addition, the locking of the zippers is achieved by the locking device and the locking pieces disposed on the pull tabs, so that the locking position of the zippers A2 can be adjusted to better fit personal habits.

While we have shown and described various embodiments in accordance with the present invention, it is clear to those skilled in the art that further embodiments may be made without departing from the scope of the present invention.

What is claimed is:

1. A double lock device for a luggage case being disposed on an outer surface of the luggage case, the luggage case comprising a case body, a first cover, a second cover, a zipper between the case body and the first cover, and another zipper between the first and second covers, the double lock device comprising:
a base being a concave hollow structure fixed on the first cover and including a first locking groove and a second locking groove formed on an upper inside of the base, and a third locking groove and a fourth locking grooves formed at a lower inside of the base, an upper clearance being formed between upper walls, lower walls of the first and second locking grooves and an inner wall of the base adjacent to the case body, and a lower clearance being formed between upper walls, lower walls of the third and fourth locking grooves and an outer wall of the base adjacent to the second cover, the upper walls of the first and second locking grooves being each formed with an upper notch, and the lower walls of the third and fourth grooves being each formed with a lower notch;
a cover covering the base and being formed with a first opening, a second opening, a third opening and a fourth opening aligned to the first, second, third and fourth locking grooves of the base, in a middle portion of the cover being further defined a slide slot;
two first locking members being an Us-shaped structure and each including a first middle section, and a first abutting portion and a first locking portion formed at two ends of the first middle section, the middle sections of the second locking members being received in the upper and lower clearances of the base in such a manner that the abutting portions are oppositely located at a middle portion of the base, and the locking portions of the first locking members are located between an upper wall of the base and the upper wall of the first locking groove, and between a lower wall of the base and the lower wall of the fourth locking groove, each of the first locking portions being formed with a first locking pin and a first protrusion which extend in opposite directions, the first locking pins being received in the upper notch of the first locking groove and the lower notch of the fourth locking groove, respectively, between each of the first protrusions and the upper and lower walls, of the base being disposed a first spring;
two second locking members being an Us-shaped structure including a second middle section, and a second abutting portion and a second locking portion formed at two ends of the second middle section, the second abutting portions of the second locking members being located at the middle portion of the base, and the second middle sections being received in the upper and lower clearances of the base and disposed on the first middle sections of the first locking members, in such a manner that the second locking portions are located between the first and second locking grooves, and between the third and fourth locking grooves of the base, respectively, each of the second locking portions being formed with a second locking pin to be disposed in the upper notch of the second locking groove and the lower notch of the third locking groove, each of the second abutting portions being formed with a second protrusion, between each of the second protrusions and the lower wall of the second locking grove and the upper wall of the third locking groove being disposed a second spring, respectively;
four elastic blocks disposed in the first, second, third and fourth locking grooves of the base for pushing the zippers out of the first, second, third and fourth locking grooves after the zippers are unlocked;
a locking unit slidably disposed in the slide slot of the cover and formed with two arc-shaped positioning portions located corresponding to the upper and lower walls of the base, and between the two arc-shaped positioning portions being provided a locking head protruding toward the base, and on the locking head being formed two guiding protrusions; and
a drive member disposed between the base and the locking unit, and including a base portion for holding the locking head, two locking notches being opened in opposite directions and located at upper and lower sides of the base portion, the base portion being formed with two arc-shaped positioning grooves for restricting slide motion of the positioning portions of the locking unit, and two arc-shaped guiding grooves which have the same radius and the same center as the arc-shaped positioning grooves, the arc-shaped guiding grooves being located closer to the center than the arc-shaped positioning grooves, and the arc-shaped guiding grooves being staggered with respect to the arc-shaped positioning grooves, the guiding protrusions being slidably disposed in the two arc-shaped guiding grooves;
by such arrangements, the drive member is rotated by the locking unit to clamp the first and second abutting portions of the first and second locking members with the locking notches, so that the first and second locking members are locked, or, the drive member is driven to slide by the locking unit, and consequently pushes the first and second abutting portions of the first and second locking members at the upper inside or lower inside of the base to move, making the first and second locking pins of the first and second locking members at the upper inside of the base move out of the first and second locking grooves, or making the first and second locking pins of the first and second locking members at the lower inside of the base move out of the third and fourth locking grooves.

2. The double lock device for the luggage case as claimed in claim 1, wherein a protruding portion is formed at a bottom of each of the first, second, third and fourth locking grooves of the base, each of the first, second, third and fourth locking grooves is further provided with two hooking portions which are located corresponding to inner and outer walls of the base, each of the elastic blocks is a M-shaped structure which includes a concave middle section and two retaining portions at both ends of the middle section, each of the concave middle section of the elastic blocks is formed with a protruding engaging portion, and a third spring disposed between each of the protruding engaging portion and each of the protruding portions, so as to push the elastic blocks toward the first, second, third and fourth openings of the cover.

3. The double lock device for the luggage case as claimed in claim 1, wherein the base is formed with two locking holes, the cover has two locking columns inserted and locked in the locking holes by two locking elements, so that the cover is fixed to the base.

4. The double lock device for the luggage case as claimed in claim 1, wherein two slide grooves are formed at two sides of the locking unit and located corresponding to the inner and outer walls of the base, and two lateral edges of the slide slot of the cover are slidably disposed in the slide grooves.

5. The double lock device for the luggage case as claimed in claim 1, wherein each of the zippers includes two rows of teeth which are disposed between the case body and between the first and second covers, two sliders and two pull tabs assembled to the sliders, each of the pull tabs includes a locking piece to be inserted in first, second, third and fourth locking grooves of a base of the lock device, and an inserting hole for insertion of the first and second locking pins of the first and second locking members.
